(19) United States
(12) Patent Application Publication
(10) Pub. No.: US 2014/0160637 A1
(43) Pub. Date: Jun. 12, 2014

(54) SERVER CABINET

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: MING-YU LIU, Shenzhen (CN); PING-CHUAN DENG, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/723,216

(22) Filed: Dec. 21, 2012

(30) Foreign Application Priority Data
Dec. 12, 2012 (CN) 201210534188.9

(51) Int. Cl. G06F 1/18

(52) U.S. Cl. CPC G06F 1/189
USPC 361/622

(57) ABSTRACT

A server cabinet includes a rack, a number of servers, a power distribution unit (PDU), and a position bracket. The rack includes a side plate and a mounting bracket extending from an inner side of the side plate. An engaging portion is formed on a front side of the mounting bracket. The servers are mounted in the rack. Front ends of the servers are fastened to a side of the mounting bracket away from the side plate. A block protrudes from the PDU and engages in the engaging portion. The position bracket includes a base plate fastened to the PDU and a position portion extending from a side of the side plate. Fasteners extend through the position portion and engage in the side plate.

### BACKGROUND

1. Technical Field

The present disclosure relates to a server cabinet.

2. Description of Related Art

A power distribution unit (PDU) of a server cabinet is generally fastened to a vertical pole of the cabinet through an L-shaped fastening tab. The fastening tab includes a first portion and a second portion perpendicular to the first portion. The first portion is fastened to the pole by a plurality of screws, and the second portion is fastened to the PDU, to make the PDU position in front of the pole. When long servers are mounted in the cabinet, the screws may be covered by the servers. An operator needs to take out the servers from the cabinet to screw or release the screws, thereby to mount or detach the PDU, which is inconvenient.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a server cabinet, wherein the server cabinet includes a power distribution unit (PDU) and a position bracket.

FIG. 2 is an enlarged view of a circled portion II of FIG. 1.

FIG. 3 is a partially enlarged view of the PDU of FIG. 1, and viewed from a different perspective.

FIG. 4 is an enlarged view of the position bracket of FIG. 1.

FIG. 5 is an assembled, isometric view of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

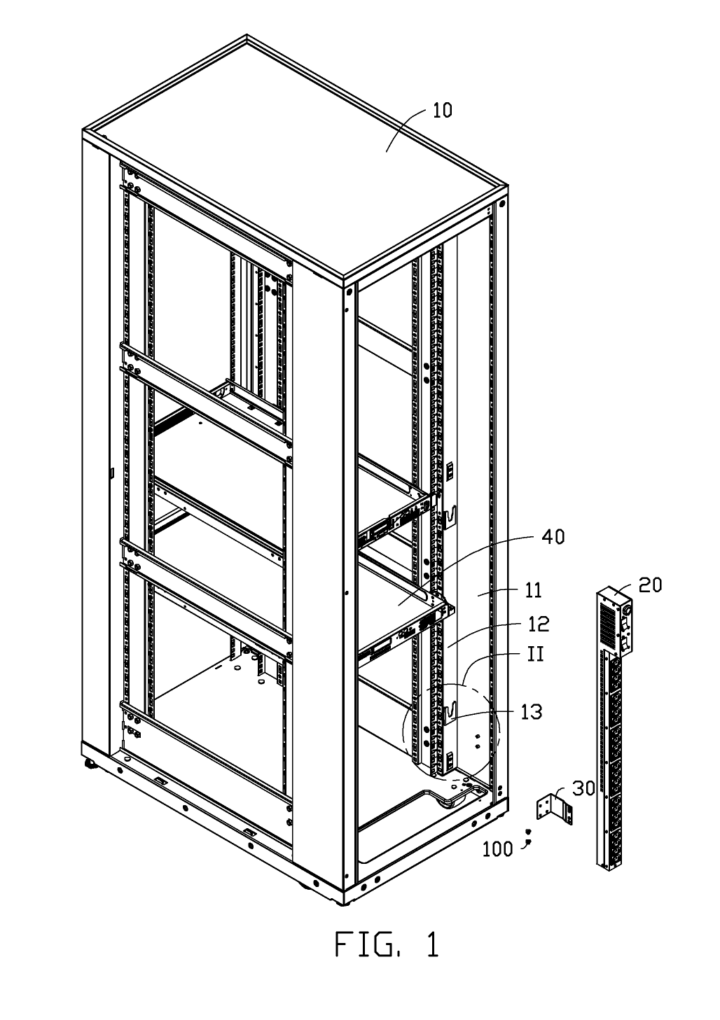

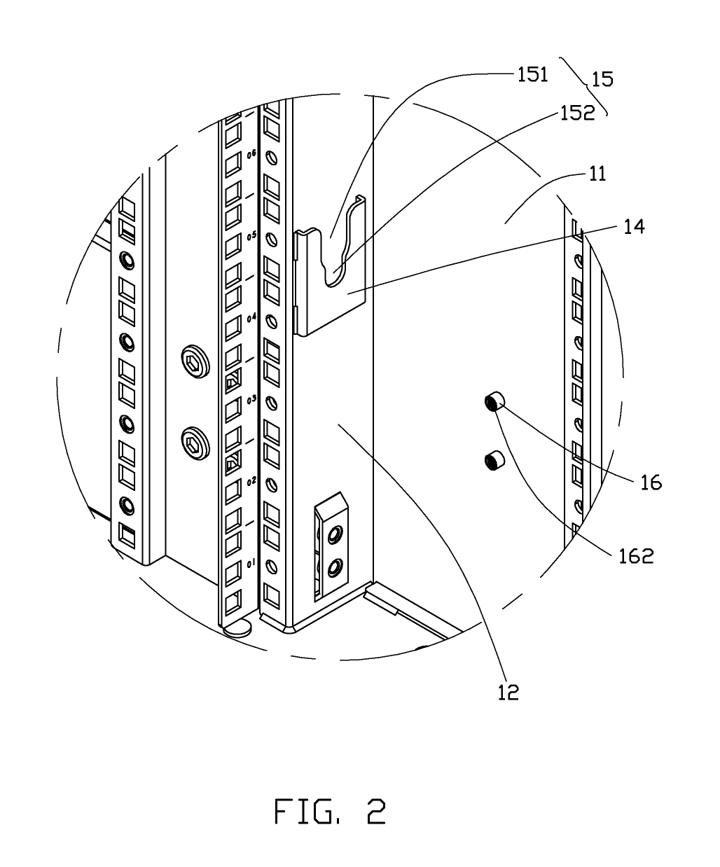

FIGS. 1 and 2 show an exemplary embodiment of a server cabinet. The server cabinet includes a rack 10, a power distribution unit (PDU) 20, a position bracket 30, and a plurality of servers 40 mounted on the rack 10.

The rack 10 includes a side plate 11. A mounting bracket 12 extends from an inner side of the side plate 11 in a substantially perpendicular manner Front ends of the servers 40 are fastened to a side of the mounting bracket 12 away from the side plate 11. Two engaging portions 13 are formed on a front side of the mounting bracket 12, arranged one above the other. Each engaging portion 13 includes a sidewall 14 spaced from and parallel to the front side of the mounting bracket 12. The sidewall 14 defines a notch 15 extending through a top of the sidewall 14. The notch 15 includes an access 151 extending through the top of the sidewall 14, and a hooking slot 152 communicating with a bottom of the access 151. The width of the hooking slot 152 is less than the width of the access 151. Two protrusions 16 protrude from the inner side of the side plate 11, located in front of the servers 40. A locking hole 162 is axially defined in each protrusion 16.

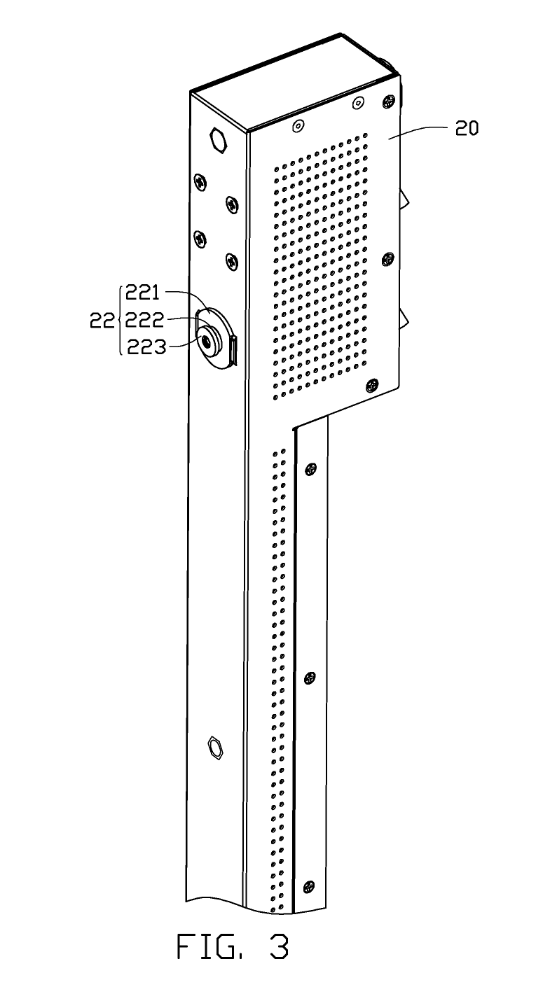

FIG. 3 shows two blocks 22 respectively protruding from upper and lower portions of a rear side of the PDU 20 (only the upper block 22 is shown in FIG. 3). Each block 22 includes a connection portion 221 protruding from the PDU 20, a columnar neck 222 protruding from the connection portion 221, and a columnar head 223 formed at a distal end of the neck 222. The head 223 is coaxial with the neck 222 and has a greater diameter than the neck 222. The diameter of the head 223 is greater than the width of the access 151.

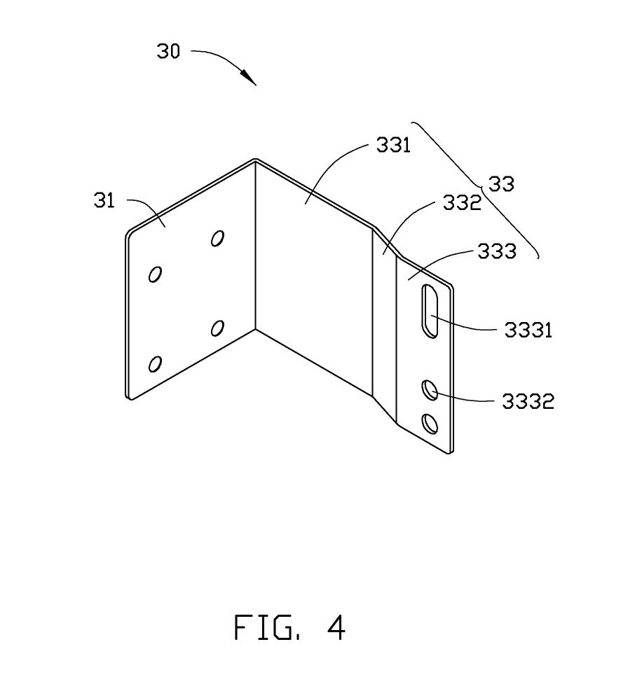

FIG. 4 shows the position bracket 30 including a base plate 31 and a position portion 33. The position portion 33 includes an extension plate 331 extending forward from a side of the base plate 31, a connection plate 332 slantingly extending forward and inward from a front side of the extension plate 331, and a fastening plate 333 extending forward from a front side of the connection plate 332. The fastening plate 333 defines an elongated first through hole 3331 extending from top to bottom, and two second through holes 3332 located below the first through hole 3331 and arranged one above the other.

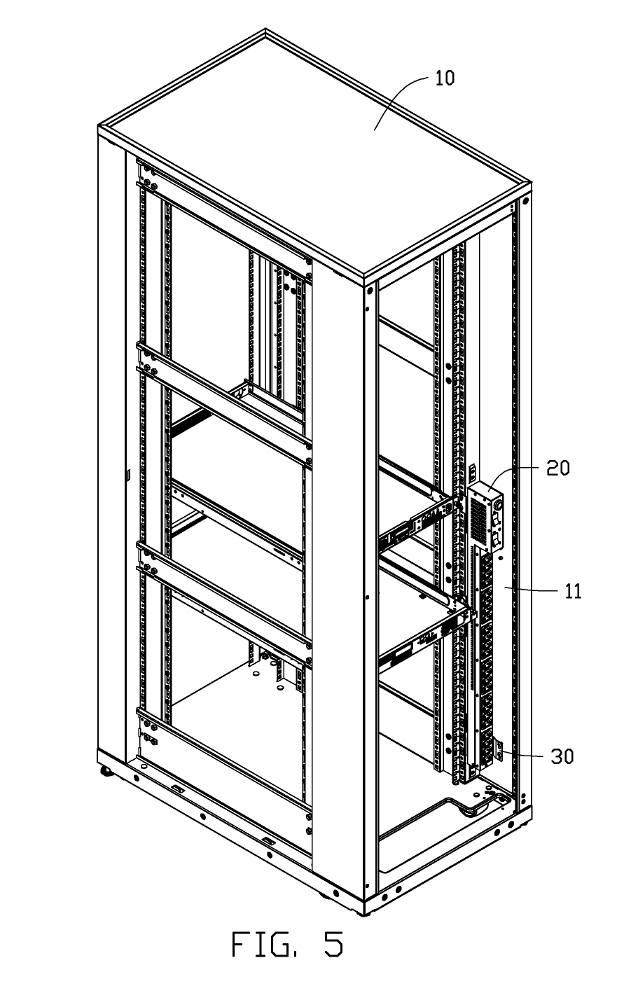

FIG. 5 shows in assembly, the base plate 31 is fastened to the rear side of the PDU 20 by screws. The position portion 33 is located between the PDU 20 and the side plate 11. The necks 222 respectively extend through the accesses 151 and engage in the hooking slots 152. The heads 223 abut inner sides of the sidewalls 14. The connection portions 221 abut outer sides of the sidewalls 14. Two fasteners 100, such as two screws, extend through the first through hole 3331 and one of the second through holes 3332 and engage in the locking holes 162. The fasteners 100 may extend through an upper portion of the first through hole 3331 and the upper second through hole 3332 and engage in the locking holes 162, or extend through a lower portion of the first through hole 3331 and the lower second through hole 3332 and engage in the locking holes 162.

The fasteners 100 extend through the position bracket 30 and engage in the side plate 11. An operator can operate the fasteners 100 to mount or detach the PDU 20 without taking out the servers 40.

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. A server cabinet, comprising:
a rack comprising a side plate and a mounting bracket extending from an inner side of the side plate, an engaging portion formed on a front side of the mounting bracket;
a plurality of servers mounted on the rack, front ends of the servers fastened to a side of the mounting bracket away from the side plate;
a power distribution unit (PDU), a block protruding from the PDU and detachably engaging in the engaging portion;
a position bracket comprising a base plate fastened to the PDU and a position portion extending from a side of the base plate; and
fasteners extending through the position portion and engaging in the side plate.

2. The server cabinet of claim 1, wherein the position portion comprises an extension plate extending forward from the side of the base plate, a connection plate slantingly extending forward and inward from a front side of the extension plate, and a fastening plate extending forward from a front side of the connection plate, the fasteners extend through the fastening plate and engage in the side plate.

3. The server cabinet of claim 1, wherein the engaging portion comprises a sidewall spaced from and parallel to the front side of the mounting bracket, the sidewall defines a notch extending through a top of the sidewall, the block comprises a neck engaging in the notch, and a head formed at a distal end of the neck to abut an inner side of the sidewall.

4. The server cabinet of claim 3, wherein the neck and the head are columnar and coaxial with each other, a diameter of the head is greater than a diameter of the neck.

5. The server cabinet of claim 3, wherein the notch comprises an access extending through the top of the sidewall, and a hooking slot communicating with a bottom of the access, a width of the hooking slot is less than a width of the access, the neck extends through the access and engages in the hooking slot.

6. The server cabinet of claim 3, wherein the block further comprises a connection portion connected to the PDU, the neck protrudes from the connection portion, the connection portion abuts an outer side of the sidewall.

7. The server cabinet of claim 1, wherein the position portion defines an elongated first through hole extending from top to bottom, and two second through holes located below the first through holes and arranged one above the other, the number of the fasteners is two, the fasteners extend through an upper portion of the first through hole and the upper second through hole and engage in the side plate, or extend through a lower portion of the first through hole and the lower second through hole and engage in the side plate.

8. The server cabinet of claim 1, wherein two protrusions protrude from the inner side of the side plate, a locking hole is defined in each protrusion, the number of the fasteners is two, the fasteners extend through the position portion and engage in the locking holes.

9. A server cabinet, comprising:
a rack comprising a side plate and a mounting bracket extending from an inner side of the side plate, an engaging portion formed on a front side of the mounting bracket;
a power distribution unit (PDU), a block protruding from the PDU and detachably engaging in the engaging portion;
a position bracket comprising a base plate fastened to the PDU and a position portion extending from a side of the base plate; and
fasteners extending through the position portion and engaging in the side plate.

10. The server cabinet of claim 9, wherein the position portion comprises an extension plate extending forward from the side of the base plate, a connection plate slantingly extending forward and inward from a front side of the extension plate, and a fastening plate extending forward from a front side of the connection plate, the fasteners extend through the fastening plate and engage in the side plate.

11. The server cabinet of claim 9, wherein the engaging portion comprises a sidewall spaced from and parallel to the front side of the mounting bracket, the sidewall defines a notch extending through a top of the sidewall, the block comprises a neck engaging in the notch, and a head formed at a distal end of the neck to abut an inner side of the sidewall.

12. The server cabinet of claim 11, wherein the neck and the head are columnar and coaxial with each other, a diameter of the head is greater than a diameter of the neck.

13. The server cabinet of claim 11, wherein the notch comprises an access extending through the top of the sidewall, and a hooking slot communicating with a bottom of the access, a width of the hooking slot is less than a width of the access, the neck extends through the access and engages in the hooking slot.

14. The server cabinet of claim 11, wherein the block further comprises a connection portion connected to the PDU, the neck protrudes from the connection portion, the connection portion abuts an outer side of the sidewall.

15. The server cabinet of claim 9, wherein the position portion defines an elongated first through hole extending from top to bottom, and two second through holes located below the first through holes and arranged one above the other, the number of the fasteners is two, the fasteners extend through an upper portion of the first through hole and the upper second through hole and engage in the side plate, or extend through a lower portion of the first through hole and the lower second through hole and engage in the side plate.

16. The server cabinet of claim 9, wherein two protrusions protrude from the inner side of the side plate, a locking hole is defined in each protrusion, the number of the fasteners is two, the fasteners extend through the position portion and engage in the locking holes.
